(19) United States
(12) Patent Application Publication
(10) Pub. No.: US 2024/0007759 A1
(43) Pub. Date: Jan. 4, 2024

(54) VIDEO USER INTERFACE AND METHOD FOR USE IN DETERMINING DEPTH INFORMATION RELATING TO A SCENE

(71) Applicant: AMS SENSORS ASIA PTE. LTD., Singapore (SG)

(72) Inventor: Alexandre VEUTHEY, Riddes (CH)

(21) Appl. No.: 18/255,588

(22) PCT Filed: Dec. 6, 2021
(86) PCT No.: PCT/SG2021/050751

§ 371 Date: Jun. 2, 2023

(30) Foreign Application Priority Data
Dec. 15, 2020 (GB) 2019760.4

(51) Int. Cl. H04N 23/95; G06T 7/521; G06T 7/80; H04N 23/53; H04N 23/55; G06F 21/32

(52) U.S. Cl. CPC H04N 23/95; G06T 7/521; G06T 7/80; H04N 23/53; H04N 23/55; G06F 21/32; G06T 2207/30201; G06T 2207/10048; G06T 2207/10024; G06T 2200/24

(57) ABSTRACT

A video user interface for an electronic device may help in determining depth information relating to a scene. comprises a display, a spatial filter defining a coded aperture, an image sensor and a lens. The scene is disposed in front of the display. The image sensor and the lens are both disposed behind the display. The spatial filter is defined by, or disposed behind, the display. The spatial filter, the image sensor, and the lens are arranged to allow the image sensor to capture an image of the scene through the coded aperture and the lens. The video user interface may be used to determine depth information relating to the scene. The video user interface may use the determined depth information to recognize one or more features in the scene, such as one or more features of a user of the electronic device in the scene, for example one or more facial features of a user of the electronic device in the scene. The video user interface may unlock the electronic device in response to recognizing one or more features in the scene.

### CROSS-REFERENCE TO RELATED APPLICATIONS

The present application is a national stage entry according to 35 U.S.C. § 371 of PCT application No.: PCT/SG2021/050751 filed on Dec. 6, 2021; which claims priority to British patent application 2019760.4, filed on Dec. 15, 2020; all of which are incorporated herein by reference in their entirety and for all purposes.

### TECHNICAL FIELD

The present disclosure relates to a video user interface for an electronic device and an associated method for use in determining depth information relating to a scene which is disposed in front of a display of the electronic device using a front-facing camera disposed behind the display, wherein the front-facing camera comprises an image sensor and a lens.

### BACKGROUND

It is known to use front-facing cameras and 3D sensors provided with a mobile electronic device such as a mobile phone for taking “selfie” pictures, making video calls, and unlocking the mobile electronic device with facial biometry information. However, in order to accommodate such front-facing cameras and 3D sensors, known mobile electronic devices generally require a dedicated area, such as a notch on a front surface of the mobile electronic device, thereby reducing the area of the front surface of the mobile electronic device which is available for displaying images. For example, referring to FIGS. 1A and 1B, there is shown a prior art mobile electronic device in the form of a mobile phone, a cell phone or a smart phone generally designated 2 including a prior art video user interface in the form of a stereo 3D imaging system generally designated 4. The mobile electronic device 2 has a front face 6 which includes a display 8 and a notch 9 having a transparent notch cover 10. The mobile electronic device 2 includes a pair of stereo imaging cameras 12 disposed behind the notch cover 10, wherein each stereo imaging camera 12 includes a corresponding lens 14 and a corresponding image sensor 16. The mobile electronic device 2 further includes a processing resource 20. As indicated by the dashed lines in FIGS. 1A and 1B, the image sensors 16 and the processing resource 20 are configured for communication. One of ordinary skill in the art will understand that, in use, each of the image sensors 16 captures an image of a scene 30 disposed in front of the mobile electronic device 2 through the corresponding lens 14 and that the processing resource 20 processes the images captured by the image sensors 16 to determine depth information relating to each of one or more regions of the scene 30.

Similarly, mobile electronic devices which incorporate a 3D sensor including a projector and a detector such as a camera also require a dedicated area, such as a notch on a front surface of the mobile electronic device, thereby reducing the area of the front surface of the mobile electronic device which is available for displaying images. In order to accommodate front-facing cameras and 3D sensors, some known mobile electronic devices even comprise articulated or pop-up parts which increase the complexity of the mobile electronic devices.

### SUMMARY

According to a first aspect of the present disclosure there is provided a video user interface for an electronic device for use in determining depth information relating to a scene, the video user interface comprising:
a display;
a spatial filter defining a coded aperture, the spatial filter being defined by, or disposed behind, the display;
an image sensor; and
a lens,
wherein the image sensor and the lens are both disposed behind the display, and
wherein the spatial filter, the image sensor, and the lens are arranged to allow the image sensor to capture an image of a scene through the coded aperture and the lens, the scene being disposed in front of the display.

The video user interface may comprise a processing resource which is configured to determine depth information relating to each of one or more regions of the scene based at least in part on the captured image and calibration data.

It should be understood that the method used by the processing resource to determine depth information relating to each of one or more regions of the scene is described in more detail in Sections 3, 4 and 5 of “Image and Depth from a Conventional Camera with a Coded Aperture”, Levin et al., ACM Transactions on Graphics, Vol. 26, No. 3, Article 70, pp. 70-1 to 70-9, which is incorporated herein by reference in its entirety. Moreover, it should be understood that protection may be sought for any of the features described in Sections 3, 4 and 5 of Levin et al.

The calibration data may comprise a plurality of calibration images of a plurality of calibration scenes and a corresponding plurality of measured depth values, wherein each calibration scene includes a point light source located at a different one of the measured depths and each calibration scene is captured by the image sensor through the coded aperture and the lens.

The measured depth value of the point light source in a corresponding calibration scene may comprise a measured distance from any part of the video user interface to the point light source in the corresponding calibration scene. For example, the measured depth value of the point light source in the corresponding calibration scene may comprise a distance from the lens of the video user interface to the point light source in the corresponding calibration scene. The measured depth value of the point light source in the corresponding calibration scene may comprise a distance from a focal plane of the lens of the video user interface to the point light source in the corresponding calibration scene, wherein the focal plane of the lens is defined such that different light rays which emanate from a point in the focal plane of the lens are focused to the same point on the image sensor.

The relative positions of the spatial filter, the image sensor and the lens when the image sensor captures the images of the point light source in the corresponding calibration scene through the coded aperture and the lens for the generation of the calibration data may be the same as the relative positions of the spatial filter, the image sensor and the lens when the image sensor captures the image of the scene through the coded aperture and the lens.

The captured image of the scene and the depth information relating to each region of the scene may together constitute a depth image or a depth map of the scene.

The processing resource may be configured to generate a depth image of the scene based on the determined depth information relating to each of one or more regions of the scene.

The depth information relating to each of the one or more regions of the scene may comprise a distance from any part of the video user interface to each of the one or more regions of the scene. For example, the depth information relating to each of one or more regions of the scene may comprise a distance from the lens of the video user interface to each of one or more regions of the scene. The depth information relating to each of one or more regions of the scene may comprise a distance from a focal plane of the lens of the video user interface to each of one or more regions of the scene, wherein the focal plane of the lens is defined such that different light rays which emanate from a point in the focal plane of the lens are focused to the same point on the image sensor.

The video user interface may be suitable for use in the generation of a depth image of the scene without sacrificing any area of the display, or by sacrificing a reduced area of the display relative to conventional video user interfaces which incorporate conventional 3D sensors. Such a video user interface may allow the generation of depth information relating to the scene using a single image sensor i.e. without any requirement for two or more image sensors, or without any requirement for a projector and an image sensor.

The video user interface may be imperceptible to, or may be effectively hidden from, a user of the electronic device.

The video user interface may be suitable for use in the recognition of one or more features in the scene. For example, such a video user interface may be suitable for use in the recognition of one or more features of a user such as one or more facial features of a user of the electronic device in the scene, for example for facial unlocking of the electronic device. Such a video user interface may allow emojis, or one or more other virtual elements, to be superimposed on top of an image of the scene captured by the image sensor through the coded aperture and the lens. Such a video user interface may allow the generation of an improved “selfie” image captured by the image sensor through the coded aperture and the lens. Such a video user interface may allow emojis, or one or more other virtual elements, to be superimposed on top of the “selfie” image captured by the image sensor through the coded aperture and the lens.

The spatial filter may comprise a binary spatial filter.

The spatial filter may comprise a plurality of spatial filter pixels, wherein the plurality of spatial filter pixels defines the coded aperture.

The spatial filter may comprise a plurality of opaque spatial filter pixels.

The plurality of opaque spatial filter pixels may define one or more gaps therebetween, wherein the one or more gaps define the coded aperture.

The spatial filter may comprise a plurality of transparent spatial filter pixels, wherein the plurality of transparent spatial filter pixels define the coded aperture.

At least some of the opaque spatial filter pixels may be interconnected or contiguous.

All of the opaque spatial filter pixels may be interconnected or contiguous. Imposing the constraint that all of the opaque spatial filter pixels of the candidate coded aperture are interconnected, may make manufacturing of the spatial filter which defines the coded aperture easier or simpler or may facilitate manufacturing of the spatial filter which defines the coded aperture according to a specific manufacturing process.

At least some of the opaque spatial filter pixels may be non-contiguous.

At least some of the transparent spatial filter pixels may be interconnected or contiguous.

At least some of the transparent spatial filter pixels may be non-contiguous.

The spatial filter may comprise a 2D array of spatial filter pixels, wherein the 2D array of spatial filter pixels defines the coded aperture.

The spatial filter may comprise a uniform 2D array of spatial filter pixels, wherein the uniform 2D array of spatial filter pixels defines the coded aperture.

The spatial filter may comprise an n×n array of spatial filter pixels, wherein the spatial filter pixels define the coded aperture and wherein n is an integer. n may be less than or equal to 100, n may be less than or equal to 20, n may be less than or equal to 15, n may be less than or equal to 13 and/or n may be less than or equal to 11.

The spatial filter may comprise an n×m array of spatial filter pixels, wherein the spatial filter pixels define the coded aperture and wherein n and m are integers. m may be less than or equal to 100, m may be less than or equal to 20, m may be less than or equal to 15, m may be less than or equal to 13 and/or m may be less than or equal to 11.

The display may comprise a light emitting diode (LED) display such as an organic light emitting diode (OLED) display.

The display and the image sensor may be synchronized so that the display emits light and the image sensor captures the image of the scene at different times. Synchronization of the display and the image sensor in this way may avoid any light from the display being captured by the image sensor to thereby prevent light from the display altering, corrupting or obfuscating the captured image of the scene.

The display may be at least partially transparent. The spatial filter may be disposed behind the display.

An area of the display may be at least partially transparent. The spatial filter may be disposed behind the at least partially transparent area of the display.

The spatial filter may be disposed between the display and the lens.

The spatial filter may be disposed between the lens and the image sensor.

The spatial filter may be integrated with the lens, for example wherein the spatial filter is integrated within a body of the lens or disposed on a surface of the lens.

The spatial filter may be disposed on a rear surface of the display on an opposite side of the display to the scene.

The display may define the spatial filter.

The display may comprise one or more at least partially transparent areas and one or more at least partially opaque areas. The spatial filter may be defined by the one or more at least partially transparent areas and the one or more at least partially opaque areas of the display. The plurality of spatial filter pixels may be defined by the one or more at least partially transparent areas and the one or more at least partially opaque areas of the display.

The one or more at least partially transparent areas of the display and/or the one or more at least partially opaque areas of the display may be temporary or transitory.

The display may comprise a plurality of light emitting pixels.

The light emitting pixels may define the spatial filter.

The light emitting pixels may define the one or more at least partially transparent areas of the display and/or the one or more at least partially opaque areas of the display.

The display may comprise one or more gaps between the light emitting pixels.

The one or more gaps between the light emitting pixels may define the spatial filter.

The one or more gaps between the light emitting pixels may define the one or more at least partially transparent areas of the display and/or the one or more at least partially opaque areas of the display.

Using the display to define the spatial filter may have a minimal impact upon a quality of an image displayed by the display. Using the display to define the spatial filter may be imperceptible by a user of the electronic device.

The image sensor may comprise a visible image sensor which is sensitive to visible light. The image sensor may comprise a visible image sensor or an RGB image sensor.

The image sensor may comprise an infra-red image sensor which is sensitive to infra-red light such as near infra-red (NIR) light. The image sensor may comprise an infra-red image sensor.

The video user interface may comprise a plurality of image sensors. For example, the video user interface may comprise an infra-red image sensor defined by, or disposed behind, the display for use in generating a depth image of a scene disposed in front of the display and a separate visible image sensor defined by, or disposed behind, the display for capturing conventional images of the scene disposed in front of the display.

The video user interface may comprise a source, emitter or projector of infra-red light for illuminating the scene with infra-red light. The source, emitter or projector of infra-red light may be disposed behind the display. Use of a source, emitter or projector of infra-red light in combination with an infra-red image sensor for use in generating a depth image of a scene disposed in front of the display may provide improved depth information relating to the scene.

The geometry of the coded aperture may be selected so as to maximize a divergence parameter value.

The divergence parameter may be defined so that the greater the divergence parameter value calculated for a given coded aperture geometry, the better the discrimination that may be achieved between regions of different depths in the image of the scene captured by the image sensor when using the given coded aperture geometry. Consequently, selecting the coded aperture geometry so as to maximize the calculated divergence parameter value, provides the maximum level of depth discrimination.

The coded aperture geometry may be selected by:
generating, for example randomly generating, a plurality of different candidate coded aperture geometries;
calculating a divergence parameter value for each candidate coded aperture geometry; and
selecting the candidate coded aperture geometry which has the maximum calculated divergence parameter value.

Calculating the divergence parameter value for each candidate coded aperture geometry may comprise:
applying a plurality of different scale factor values to the geometry of the candidate coded aperture to obtain a plurality of scaled versions of the candidate coded aperture;
calculating a divergence parameter value for each different pair of scaled versions of the candidate coded aperture selected from the plurality of scaled versions of the candidate coded aperture; and
identifying the divergence parameter value for each candidate coded aperture geometry as the minimum divergence parameter value calculated for any different pair of scaled versions of the candidate coded aperture selected from the plurality of scaled versions of the candidate coded aperture.

The plurality of different scale factor values may be selected from a predetermined range of scale factor values, wherein each scale factor value corresponds to a different depth of a point source in a corresponding calibration scene selected from a predetermined range of depths of the point source.

Calculating the divergence parameter value for each different pair of scaled versions of the candidate coded aperture may comprise calculating the divergence parameter value based on a statistical blurry image intensity distribution for each of the two scaled versions of the candidate coded aperture of each different pair of scaled versions of the candidate coded aperture.

The divergence parameter may comprise a Kullback-Leibler divergence parameter DKL defined by:

D_{KL}[Pₖ₁(y), Pₖ₂(y)]=∫_{y}Pₖ₁(y)[log Pₖ₁(y)−log Pₖ₂(y)]dy

where y is a blurry image, such as a simulated blurry image, of a point light source captured by the image sensor through the candidate coded aperture, and Pₖ₁(y) and Pₖ₂(y) are the statistical blurry image intensity distributions of the blurry image y at different scale factor values k₁ and k₂ corresponding to different depths of the point light source in a scene. Each of the statistical blurry image intensity distributions Pₖ₁(y) and Pₖ₂(y) may follow a Gaussian distribution.

It should be understood that the method described above for selecting the geometry of the coded aperture is described in more detail in Section 2 of Levin et al. and that protection may be sought for any of the features described in Section 2 of Levin et al.

According to an aspect of the present disclosure there is provided an electronic device comprising the video user interface as described above.

The electronic device may be mobile and/or portable. For example, the electronic device may comprise a phone such as a mobile phone, a cell phone, or a smart phone, or wherein the electronic device comprises a tablet or a laptop.

According to an aspect of the present disclosure there is provided a method for use in determining depth information relating to a scene using a video user interface, wherein the video user interface comprises a display, a spatial filter defining a coded aperture, an image sensor and a lens, and the method comprises:
capturing an image of a scene through the coded aperture and the lens using the image sensor, the image sensor and the lens both being disposed behind the display, the scene being disposed in front of the display, and the spatial filter being defined by, or disposed behind, the display.

The method may comprise determining depth information relating to each of one or more regions of the scene based at least in part on the captured image and calibration data.

The calibration data may comprise a plurality of calibration images of a plurality of calibration scenes and a corresponding plurality of measured depth values, wherein each calibration scene includes a point light source located at a different one of the measured depths and each calibration scene is captured by the image sensor through the coded aperture and the lens.

The measured depth of the point light source in the corresponding calibration scene may comprise a measured distance from any part of the video user interface to the point light source in the corresponding calibration scene. For example, the measured depth of the point light source in the corresponding calibration scene may comprise a measured distance from the lens of the video user interface to the point light source in the corresponding calibration scene. The measured depth of the point light source in the corresponding calibration scene may comprise a measured distance from a focal plane of the lens of the video user interface to the point light source in the corresponding calibration scene, wherein the focal plane of the lens is defined such that different light rays which emanate from a point in the focal plane of the lens are focused to the same point on the image sensor.

The relative positions of the spatial filter, the image sensor and the lens when the image sensor captures the images of the point light source in the corresponding calibration scene through the coded aperture and the lens for the generation of the calibration data may be the same as the relative positions of the spatial filter, the image sensor and the lens when the image sensor captures the image of the scene through the coded aperture and the lens.

The captured image of the scene and the depth information relating to each region of the scene may together constitute a depth image or a depth map of the scene.

The depth information relating to each of the one or more regions of the scene may comprise a distance from any part of the video user interface to each of the one or more regions of the scene. For example, the depth information relating to each of one or more regions of the scene may comprise a distance from the lens of the video user interface to each of one or more regions of the scene. The depth information relating to each of one or more regions of the scene may comprise a distance from a focal plane of the lens of the video user interface to each of one or more regions of the scene, wherein the focal plane of the lens is defined such that different light rays which emanate from a point in the focal plane of the lens are focused to the same point on the image sensor.

The method may comprise:
deblurring a captured image y of the scene using each calibration image fₖ of the plurality of calibration images one-by-one to generate a corresponding plurality of deblurred images xₖ of the scene;
dividing the captured image of the scene into a plurality of j regions; and
for each region j:
   selecting region j of one of the deblurred images xₖ of the scene so as to minimize ringing artefacts in an overall deblurred image x; and
   determining the calibration distance corresponding to the calibration image fₖ used to generate the region j of the deblurred image xₖ which is selected as region j of deblurred image x.

Deblurring the captured image yof the scene using each calibration image fₖ may comprise deconvolving the captured image y of the scene using each calibration image fₖ.

It should be understood that the method for use in generating the depth image of the scene is described in more detail in Sections 3, 4 and 5 of Levin et al. and that protection may be sought for any of the features described in Sections 3, 4 and 5 of Levin et al.

The method may comprise using the determined depth information relating to each of one or more regions of the scene to generate an all-focus image of the scene. It should be understood that the all-focus image of the scene may be generated using the method described at Section 5.2 of Levin et al. and that protection may be sought for any of the features described in Section 5.2 of Levin et al.

Similarly, the method may comprise using the determined depth information relating to each of one or more regions of the scene to generate a re-focused image of the scene. It should be understood that the refocused image of the scene may be generated using the method described at Section 5.4 of Levin et al. and that protection is may be sought for any of the features described in Section 5.4 of Levin et al.

The method may comprise performing a calibration procedure to generate the calibration data.

Performing the calibration procedure may comprise:
capturing the calibration image of each calibration scene of the plurality of calibration scenes through the coded aperture and the lens using the image sensor;
measuring the depth of the point light source in each calibration scene; and
associating the determined scale factor value with the measured depth of the point light source in the corresponding calibration scene.

It should also be understood that the calibration procedure is described in more detail in Section 5.1 of Levin et al. and that protection may be sought for any of the features described in Section 5.1 of Levin et al.

The method may comprise generating a depth image of the scene based on the determined depth information relating to each of one or more regions of the scene.

According to an aspect of the present disclosure there is provided a method for recognizing one or more features in a scene, comprising:
the method as described above; and
using the determined depth information relating to each of one or more regions of the scene to recognize one or more features in the scene.

The one or more features in the scene may comprise one or more features of a user of the electronic device in the scene.

The one or more features in the scene may comprise one or more facial features of a user of the electronic device in the scene.

According to an aspect of the present disclosure there is provided a method for unlocking an electronic device, the method comprising:
unlocking the electronic device in response to recognizing one or more features in the scene.

The method may comprise unlocking the electronic device in response to recognizing one or more features of a user of the electronic device in the scene.

The method may comprise unlocking the electronic device in response to recognizing one or more facial features of a user of the electronic device in the scene.

It should be understood that any one or more of the features of any one of the foregoing aspects of the present disclosure may be combined with any one or more of the features of any of the other foregoing aspects of the present disclosure.

### BRIEF DESCRIPTION OF THE DRAWINGS

A video user interface for an electronic device and associated methods will now be described by way of non-limiting example only with reference to the accompanying drawings of which:

FIG. 1A is a schematic front view of a mobile electronic device including a prior art video user interface;

FIG. 1B is a schematic cross-section on AA through the prior art video user interface of the mobile electronic device of FIG. 1A;

FIG. 2A is a schematic front view of a mobile electronic device including a video user interface;

FIG. 2B is a schematic cross-section on AA through the video user interface of the mobile electronic device of FIG. 2A;

FIG. 3 illustrates a spatial filter of the video user interface of FIGS. 2A and 2B;

FIG. 4 illustrates a method for use in generating a depth image of a scene using the video user interface of FIGS. 2A and 2B;

FIG. 5 illustrates a calibration procedure for the video user interface of FIGS. 2A and 2B;

FIG. 6A illustrates a candidate spatial filter having a candidate coded aperture for use with the video user interface of FIGS. 2A and 2B;

FIG. 6B illustrates a first scaled version of the candidate spatial filter of FIG. 6A;

FIG. 6C illustrates a second scaled version of the candidate spatial filter of FIG. 6A;

FIG. 7 illustrates a plurality of randomly generated symmetric candidate coded aperture geometries;

FIG. 8 illustrates a plurality of randomly generated symmetric candidate coded aperture geometries, wherein the candidate coded aperture geometries are subject to the constraint that all of the opaque pixels of the candidate coded aperture are interconnected;

FIG. 9 illustrates a plurality of randomly generated asymmetric candidate coded aperture geometries;

FIG. 10 illustrates a plurality of randomly generated asymmetric candidate coded aperture geometries, wherein the candidate coded aperture geometries are subject to the constraint that all of the opaque pixels of the candidate coded aperture are interconnected;

FIG. 11 is a schematic cross-section of a first alternative video user interface for use with a mobile electronic device;

FIG. 12 is a schematic cross-section of a second alternative video user interface for use with a mobile electronic device;

FIG. 13 is a schematic cross-section of a third alternative video user interface for use with a mobile electronic device; and

FIG. 14 is a schematic cross-section of a fourth alternative video user interface for use with a mobile electronic device.

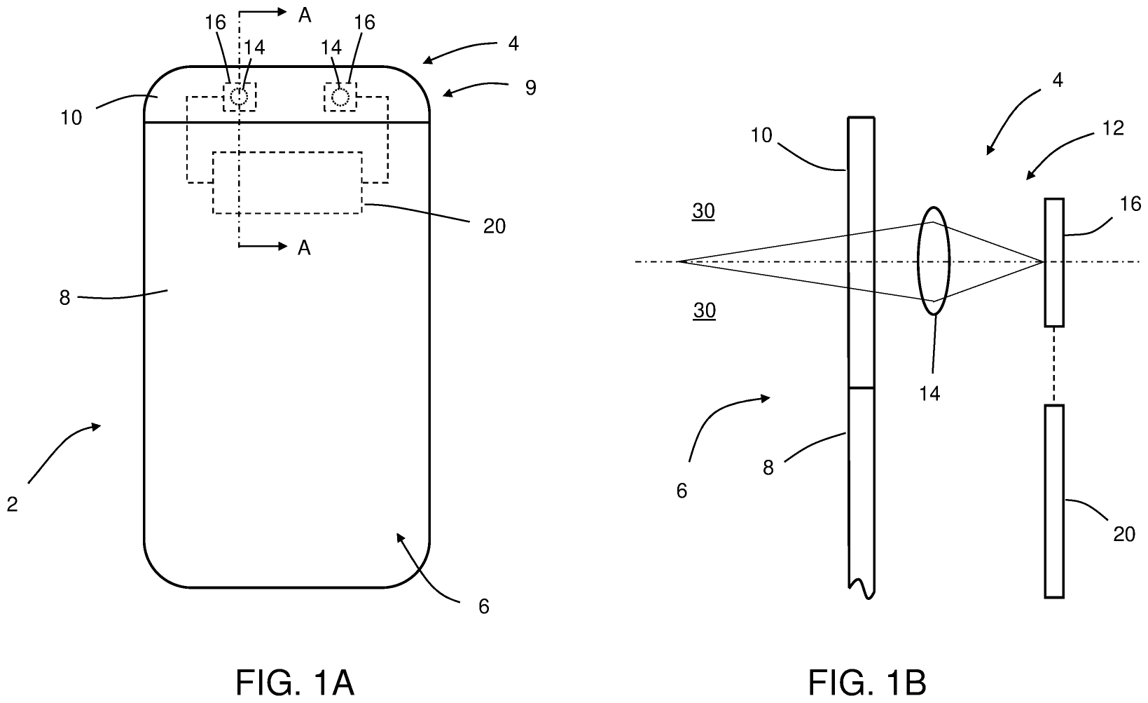

### DETAILED DESCRIPTION

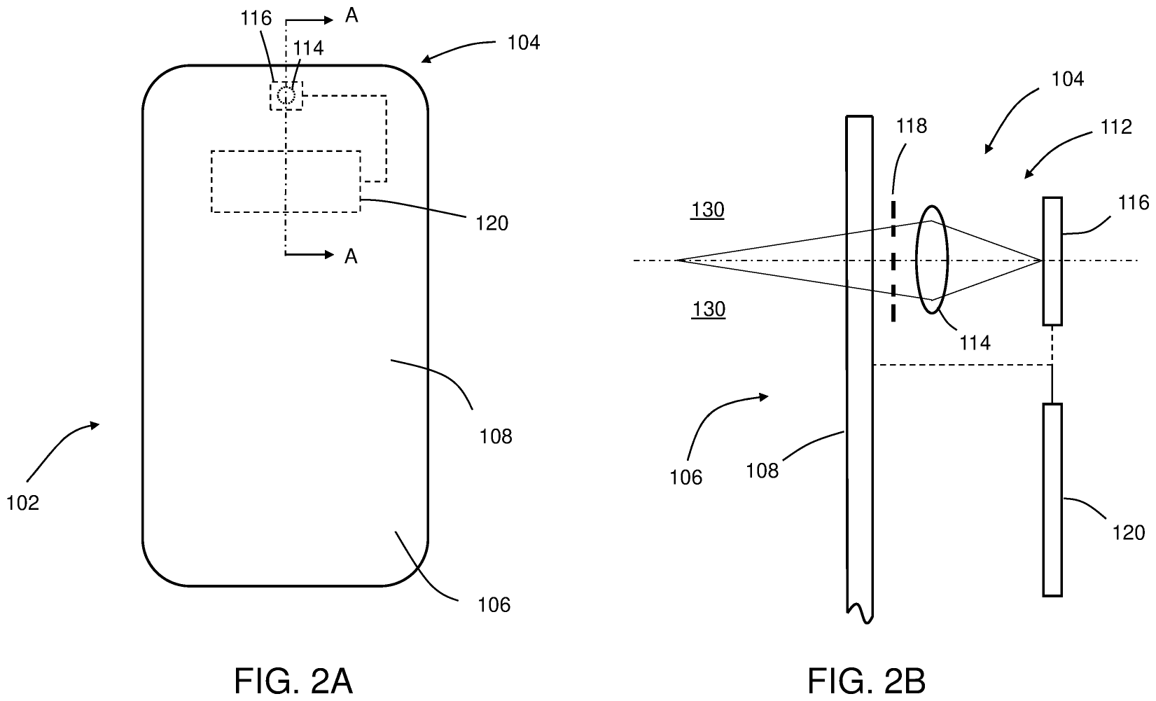

Referring initially to FIGS. 2A and 2B, there is shown an electronic device in the form of a mobile electronic device generally designated 102 including a video user interface generally designated 104 for use in determining depth information relating to a scene 130. The mobile electronic device 102 has a front face 106 disposed towards the scene 130. The video user interface 104 includes a transparent OLED display 108 which defines the front face 106 of the mobile electronic device 102. The video user interface 104 includes a camera 112 disposed behind the display 108, wherein the camera 112 includes a lens 114 and an image sensor 116. The video user interface 104 further includes a spatial filter 118 which defines a coded aperture and which is disposed behind the display 108 between the display 108 and the lens 114. The mobile electronic device 102 further includes a processing resource 120. As indicated by the dashed lines in FIGS. 2A and 2B, the display 108, the image sensor 116 and the processing resource 120 are configured for communication.

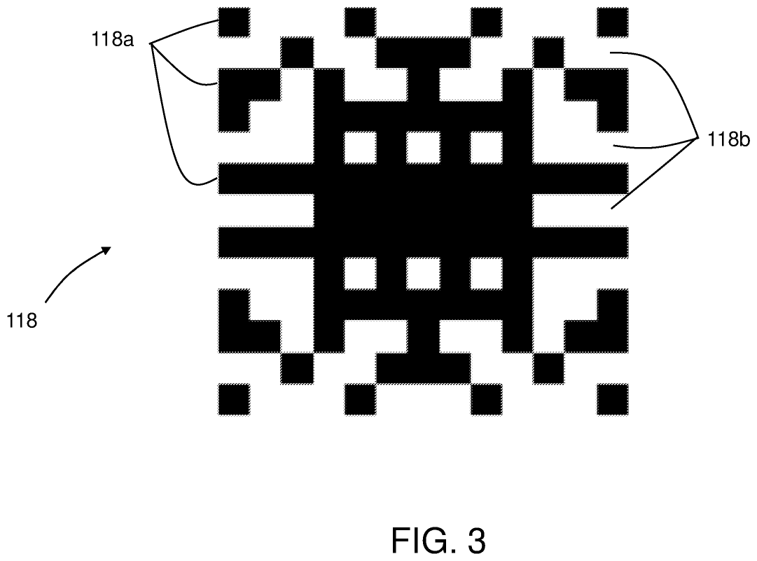

Referring to FIG. 3 there is shown a front view of the spatial filter 118. As may be appreciated from FIG. 3, the spatial filter 118 includes a 13×13 array of binary spatial filter pixels, wherein the array of binary spatial filter pixels defines a coded aperture. Specifically, the spatial filter 118 includes a 13×13 array of binary spatial filter pixels including a plurality of opaque spatial filter pixels 118a and a plurality of gaps or transparent spatial filter pixels 118b, wherein the plurality of gaps or transparent spatial filter pixels 118b defines a geometry of the coded aperture.

In use, the image sensor 116 captures an image of the scene 130 disposed in front of the mobile electronic device 102 through the display 108, the coded aperture of the spatial filter 118, and the lens 114, and the processing resource 120 processes the image captured by the image sensor 116 to determine depth information relating to each of one or more regions of the scene 130.

The processing resource 120 synchronizes the display 108 and the image sensor 116 so that the display 108 emits light and the image sensor 116 captures the image of the scene 130 at different times. Synchronization of the display 108 and the image sensor 116 in this way may avoid any light from the display 108 being captured by the image sensor 116 to thereby prevent light from the display 108 altering, corrupting or obfuscating the captured image of the scene 130.

The image of the scene 130 captured by the image sensor 116 and the depth information relating to each region of the scene 130 may together constitute a depth image or a depth map of the scene 130. The depth information relating to each of the one or more regions of the scene 130 may comprise a distance from any part of the video user interface 104 to each of the one or more regions of the scene 130. For example, the depth information relating to each of one or more regions of the scene 130 may comprise a distance from the lens 114 of the video user interface 104 to each of one or more regions of the scene 130. The depth information relating to each of one or more regions of the scene 130 may comprise a distance from a focal plane of the lens 114 of the video user interface 104 to each of one or more regions of the scene 130, wherein the focal plane of the lens 114 is defined such that different light rays which emanate from a point in the focal plane of the lens 114 are focused to the same point on the image sensor 116.

As will be described in more detail below, the processing resource 120 is configured to determine depth information relating to each of one or more regions of the scene 130 based at least in part on the image of the scene 130 captured by the image sensor 120 and calibration data. As will be understood by one skilled in the art, the spatial filter 118 allows light to reach the image sensor 116 in a specifically calibrated pattern, which can be decoded to retrieve depth information. Specifically, as may be appreciated from “Image and Depth from a Conventional Camera with a Coded Aperture”, Levin et al., ACM Transactions on Graphics, Vol. 26, No. 3, Article 70, pp. 70-1 to 70-9, which is incorporated herein by reference in its entirety, when compared with a conventional uncoded aperture, the coded aperture defined by the spatial filter 118 may be used to provide improved depth discrimination between different regions of an image of a scene having different depths. Accordingly, it should be understood that protection may be sought for any of the features of Levin et al.

The calibration data comprises a plurality of calibration images of a plurality of calibration scenes and a corresponding plurality of measured depth values, wherein each calibration scene includes a point light source located at a different one of the measured depths and each calibration scene is captured by the image sensor 116 through the coded aperture and the lens 114. The measured depth of the point light source in a corresponding calibration scene comprises a measured distance from any part of the video user interface 104 to the point light source in the corresponding calibration scene. For example, the measured depth of the point light source in the corresponding calibration scene may comprise a measured distance from the lens 114 to the point light source in the corresponding calibration scene. The measured depth of the point light source in the corresponding calibration scene may comprise a measured distance from a focal plane of the lens 114 to the point light source in the corresponding calibration scene, wherein the focal plane of the lens 114 is defined such that different light rays which emanate from a point in the focal plane of the lens 114 are focused to the same point on the image sensor 116.

It should be understood that the relative positions of the spatial filter 118, the image sensor 116 and the lens 114 when the image sensor 116 captures the images of the point light source in the corresponding calibration scene through the coded aperture and the lens 114 for the generation of the calibration data, should be the same as the relative positions of the spatial filter 118, the image sensor 116 and the lens 114 when the image sensor 116 captures the image of the scene 130 through the coded aperture and the lens 114.

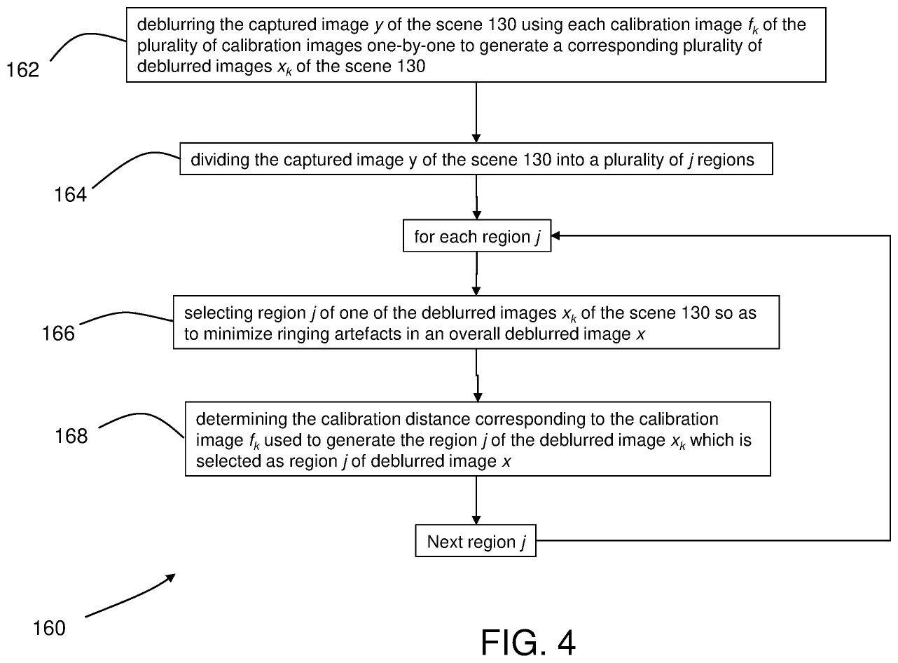

Referring to FIG. 4, the processing resource 120 performs a method generally designated 160 for use in generating depth information relating to the scene 130, which method comprises the steps of:
deblurring 162 a captured image y of the scene 130, for example by deconvolution, using each calibration image fₖ of the plurality of calibration images one-by-one to generate a corresponding plurality of deblurred images xₖ of the scene 130;
dividing 164 the captured image y of the scene 130 into a plurality of j regions; and
for each region j:
   selecting 166 region j of one of the deblurred images xₖ of the scene 130 so as to minimize ringing artefacts in an overall deblurred image x; and
   determining 168 the calibration distance corresponding to the calibration image fₖ used to generate the region j of the deblurred image xₖ which is selected as region j of deblurred image x.

In effect, the calibration distance determined at step 168 for each region j of the scene 130 provides depth information relating to each region j of the scene 130. For example, the captured image of the scene 130 and the calibration distance determined at step 168 for each region j of the scene 130 may together be considered to constitute a depth image or a depth map of the scene 130.

It should be understood that the method generally designated 160 for use in generating depth information relating to the scene 130 is described in more detail in Sections 3, 4 and 5 of Levin et al. and that protection may be sought for any of the features described in Sections 3, 4 and 5 of Levin et al.

Furthermore, as will be understood by one of ordinary skill in the art, the depth information relating to the scene 130 may be used to generate an all-focus image of the scene 130 as described at Section 5.2 of Levin et al. and/or to generate a re-focused image of the scene 130 as described at Section 5.4 of Levin et al. Accordingly, it should be understood that protection may be sought for any of the features described in Sections 5.2 and/or 5.4 of Levin et al.

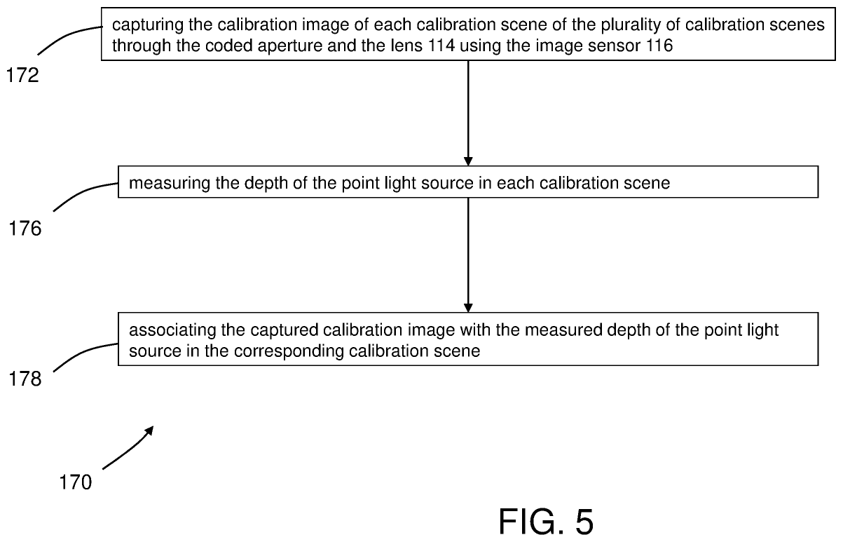

The calibration data is generated by performing a calibration procedure 170 which is illustrated in FIG. 5 and which comprises the steps of:
capturing 172 the calibration image of each calibration scene of the plurality of calibration scenes through the coded aperture and the lens 114 using the image sensor 116;
measuring 176 the depth of the point light source in each calibration scene; and
associating 178 the determined scale factor value with the measured depth of the point light source in the corresponding calibration scene.

It also should be understood that the calibration procedure 170 is described in more detail in Section 5.1 of Levin et al. and that protection may be sought for any of the features described in Section 5.1 of Levin et al.

The geometry of the coded aperture defined by the spatial filter 118 may be optimized by selecting the geometry of the coded aperture so as to maximize a divergence parameter value. The divergence parameter is defined so that the greater the divergence parameter value calculated for a given coded aperture geometry, the better the depth discrimination that is achieved between regions of different depths in the image of the scene 130 captured by the image sensor 116 when using the given coded aperture geometry. Specifically, the coded aperture geometry is selected by generating, for example randomly generating, a plurality of different candidate coded aperture geometries, calculating a divergence parameter value for each candidate coded aperture geometry, and selecting the candidate coded aperture geometry which has the maximum calculated divergence parameter value.

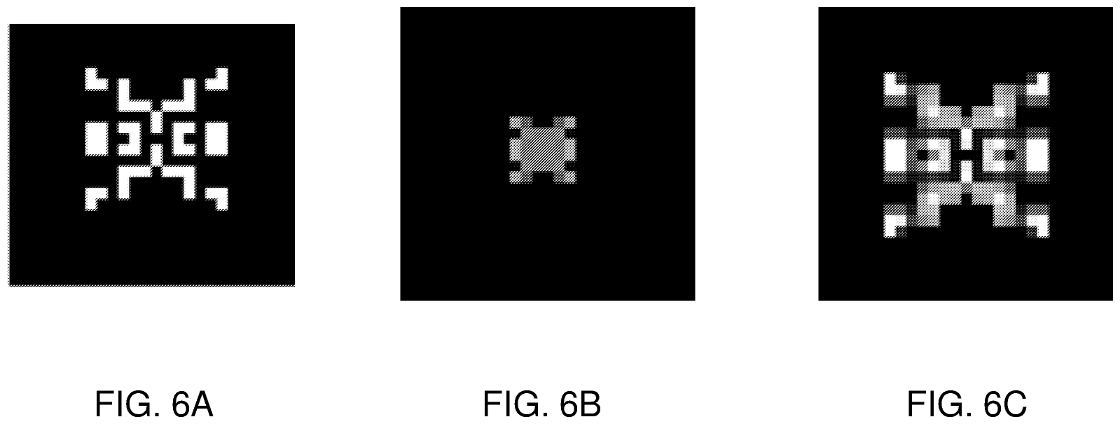

Specifically, the divergence parameter value for each candidate coded aperture geometry is calculated by applying a plurality of different scale factor values to the geometry of the candidate coded aperture to obtain a plurality of scaled versions of the candidate coded aperture, calculating a divergence parameter value for each different pair of scaled versions of the candidate coded aperture selected from the plurality of scaled versions of the candidate coded aperture, and identifying the divergence parameter value for each candidate coded aperture geometry as the minimum divergence parameter value calculated for any different pair of scaled versions of the candidate coded aperture selected from the plurality of scaled versions of the candidate coded aperture. For example, FIG. 6A shows a candidate coded aperture of the spatial filter 118 having 13×13 spatial filter pixels. A first scale factor value is applied to the 13×13 pixel candidate coded aperture of FIG. 6A to re-size the candidate coded aperture of FIG. 6A by re-sampling to obtain a 6×6 pixel scaled version of the candidate coded aperture as shown in FIG. 6B. Similarly, a second scale factor value is applied to the 13×13 pixel candidate coded aperture of FIG. 6A to re-size the candidate coded aperture of FIG. 6A by re-sampling to obtain a 15×15 pixel scaled version of the candidate coded aperture as shown in FIG. 6C. It should be understood that the scaled versions of the candidate coded aperture shown in FIGS. 6B and 6C are re-centred on a larger black background for visualization purposes only and that the divergence parameter is not influenced by the position of the candidate coded aperture. As may also be appreciated from the scaled versions of the candidate coded aperture shown in FIGS. 6B and 6C, the candidate coded aperture is not only re-sized, but is also distorted as a result of the scaling. The objective of scaling the candidate coded aperture by different scaling factors as described above is to simulate how a point light source would appear on the image sensor 116 when the point light source is located at different depths in a scene relative to the video user interface 104 and imaged through the candidate coded aperture. The depth of the point light source relative to the video user interface 104 may comprise a distance from any part of the video user interface 104 to the point light source. For example, the depth of the point light source relative to the video user interface 104 may comprise a distance from the lens 114 to the point light source. The depth of the point light source relative to the video user interface 104 may comprise a distance from a focal plane of the lens 114 to the point light source, wherein the focal plane of the lens 114 is defined such that different light rays which emanate from a point in the focal plane of the lens 114 are focused to the same point on the image sensor 116.

The plurality of different scale factor values applied to each candidate coded aperture geometry is selected from a predetermined range of scale factor values, wherein each scale factor value corresponds to a different depth of the point light source in a scene selected from a predetermined range of depths of the point light source. For the example of the specific candidate coded aperture geometry of FIGS. 6A-6C, three different scale factor values are selected, namely 6×6 pixels, 13×13 pixels, and 15×15 pixels. It should be understood that, in general, the number of different scale factor values selected may be fewer of greater than three. For example, the number of different scale factor values selected may be between 5 and 10 or may be between 10 and 20.

The divergence parameter value for each different pair of scaled versions of the candidate coded aperture is calculated by calculating the divergence parameter value based on a statistical blurry image intensity distribution for each of the two scaled versions of the candidate coded aperture of each different pair of scaled versions of the candidate coded aperture. Specifically, the divergence parameter value for each different pair of scaled versions of the candidate coded aperture is calculated by calculating a Kullback-Leibler divergence parameter DKL defined by:

D_{KL}[Pₖ₁(y), Pₖ₂(y)]=∫_{y}Pₖ₁(y)[log Pₖ₁(y)−log Pₖ₂(y)]dy
where y is a simulated blurry image of a point light source captured by the image sensor 116 through the candidate coded aperture, Pₖ₁(y) and Pₖ₂(y) are the statistical blurry image intensity distributions of the blurry image y at different scale factor values k₁ and k₂ corresponding to different depths of the point light source in a scene, and each of the statistical blurry image intensity distributions Pₖ₁(y) and Pₖ₂(y) follows a Gaussian distribution.

Thus, for the example of the specific candidate coded aperture geometry of FIGS. 6A-6C, a D_{KL} value is calculated for each of the three different pairs of the scaled versions of the candidate coded aperture: 1) a D_{KL} value calculated for the candidate coded aperture scaled to 6×6 pixels and the candidate coded aperture scaled to 13×13 pixels; 2) a D_{KL} value calculated for the candidate coded aperture scaled to 13×13 pixels and the candidate coded aperture scaled to 15×15 pixels; and 3) a D_{KL} value calculated for the candidate coded aperture scaled to 6×6 pixels and the candidate coded aperture scaled to 15×15 pixels. The divergence parameter value for the candidate coded aperture geometry of FIGS. 6A-6C is then identified as the minimum D_{KL} value calculated for the different pairs of the scaled versions of the candidate coded aperture.

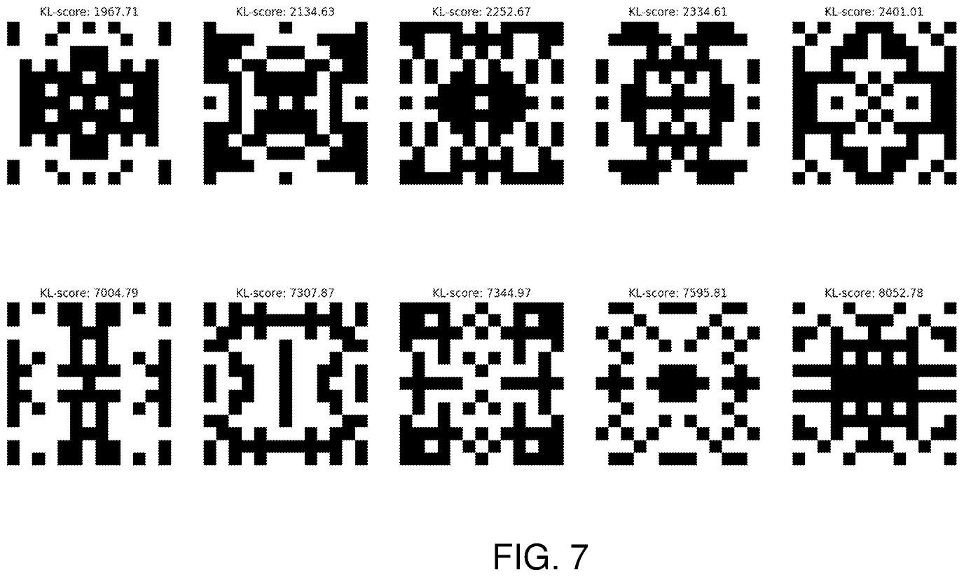

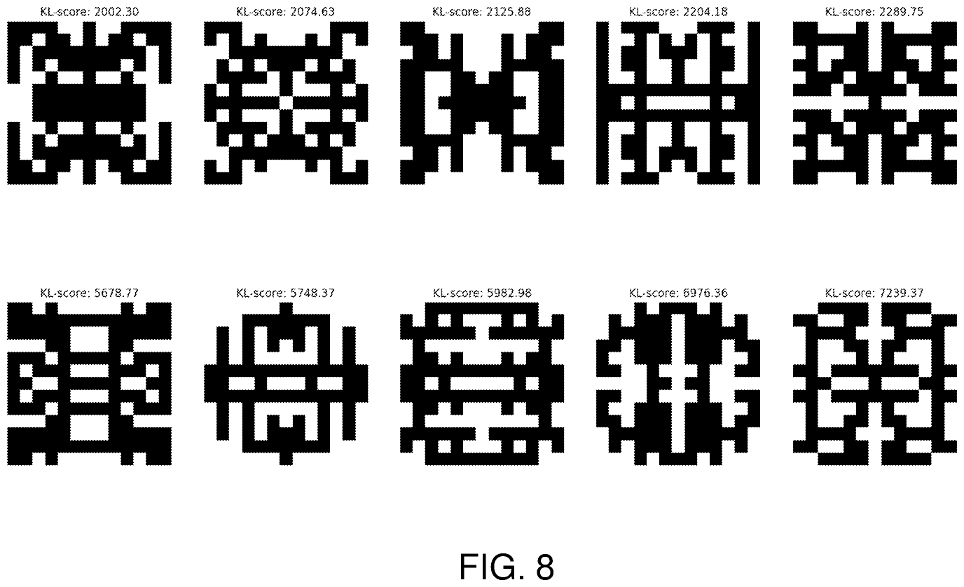

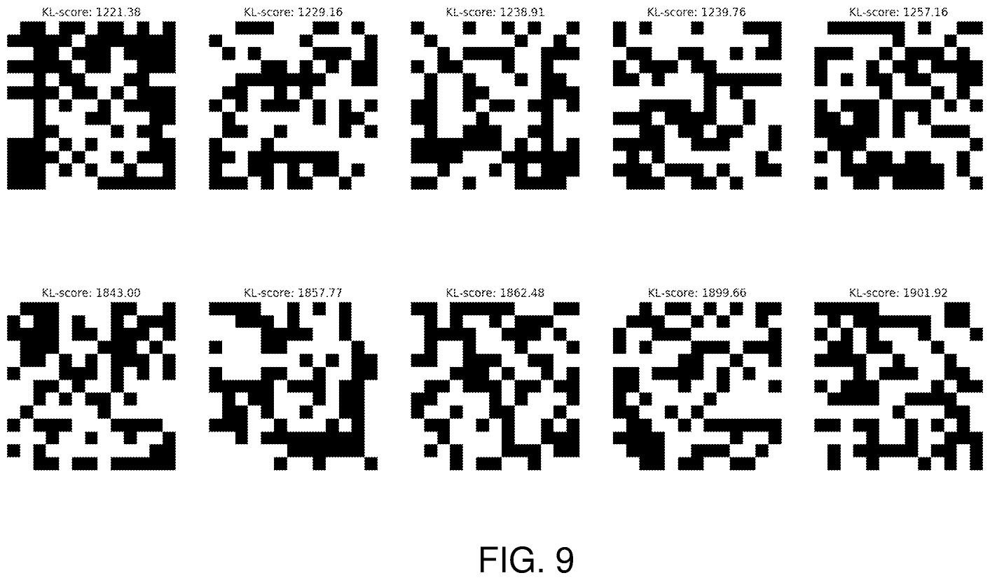

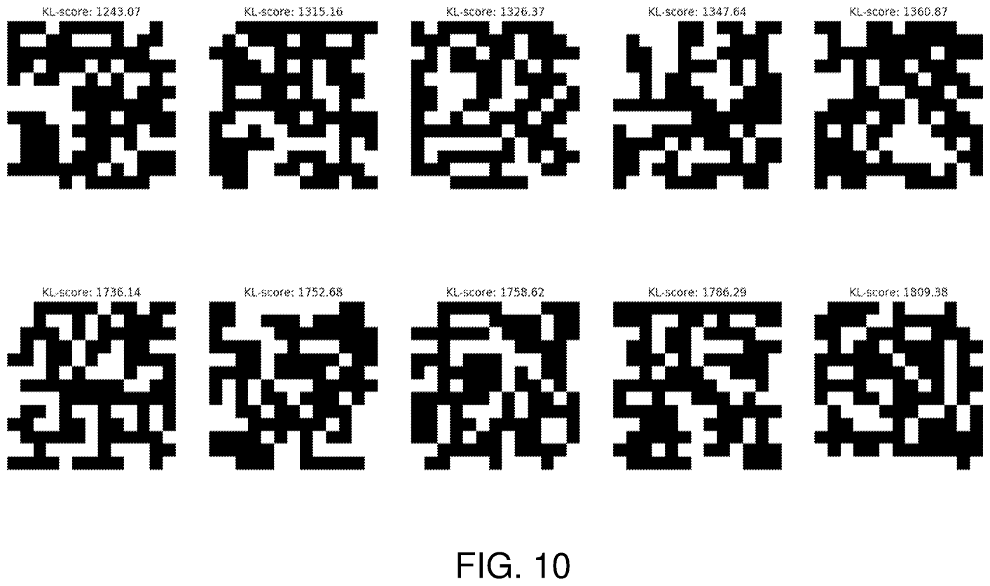

The divergence parameter value calculated for the candidate coded aperture geometry is then compared to divergence parameter values calculated for one or more other candidate coded aperture geometries and the candidate coded aperture geometry having the maximum divergence parameter value is selected for the spatial filter 118. For example, FIG. 7 shows a plurality of randomly generated symmetric candidate coded aperture geometries and their corresponding D_{KL} values, each geometry having 13×13 spatial filter pixels. Similarly, FIG. 8 shows a plurality of randomly generated symmetric candidate coded aperture geometries and their corresponding D_{KL} values, wherein each geometry has 13×13 spatial filter pixels, and wherein the candidate coded aperture geometries are subject to the constraint that all of the opaque pixels of the candidate coded aperture are interconnected. Imposing the constraint that all of the opaque pixels of the candidate coded aperture are interconnected, may make manufacturing of the spatial filter which defines the coded aperture easier or simpler or may facilitate manufacturing of the spatial filter which defines the coded aperture according to a specific manufacturing process. FIG. 9 shows a plurality of randomly generated asymmetric candidate coded aperture geometries and their corresponding D_{KL} values, each geometry having 13×13 spatial filter pixels. Similarly, FIG. 10 shows a plurality of randomly generated asymmetric candidate coded aperture geometries and their corresponding D_{KL} values, wherein each geometry has 13×13 spatial filter pixels, and wherein the candidate coded aperture geometries are subject to the constraint that all of the opaque pixels of the candidate coded aperture are interconnected. Based on all of the candidate coded aperture geometries shown in FIGS. 7-10, the candidate coded aperture geometry with the greatest D_{KL} value is the symmetric candidate coded aperture geometry shown in the bottom right corner of FIG. 7. Accordingly, the symmetric candidate coded aperture geometry shown in the bottom right corner of FIG. 7 was selected for the spatial filter 118 shown in FIGS. 2B and 3.

It should be understood that the method described above for selecting the geometry of the coded aperture is described in more detail in Section 2 of Levin et al. and that protection may be sought for any of the features described in Section 2 of Levin et al.

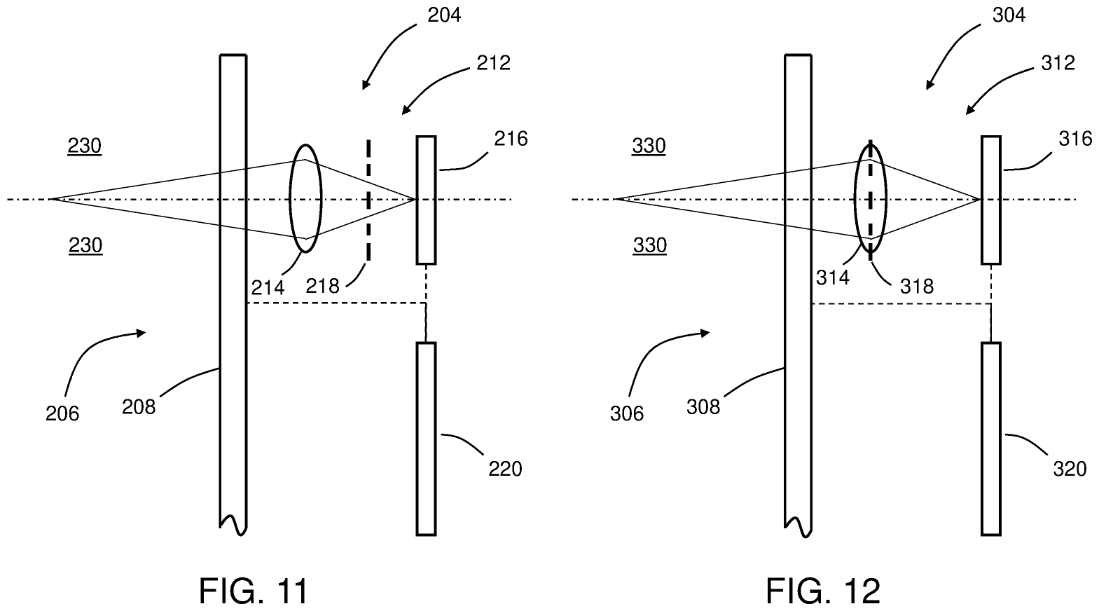

Referring now to FIG. 11, there is shown a schematic cross-section of a first alternative video user interface generally designated 204 for use with a mobile electronic device for use in generating a depth image of a scene 230. The first alternative video user interface 204 of FIG. 11 has features which correspond to the features of the video user interface 104 of FIGS. 2A and 2B, with the features of the alternative video user interface 204 of FIG. 11 being identified with the same reference numerals as the corresponding features of the video user interface 104 of FIGS. 2A and 2B incremented by “100”. The video user interface 204 includes a transparent OLED display 208 which defines a front face 206 of the mobile electronic device. The video user interface 204 includes a camera 212 disposed behind the display 208, wherein the camera 212 includes a lens 214 and an image sensor 216. The video user interface 204 further includes a spatial filter 218 which defines a coded aperture. Like the spatial filter 118 of the video user interface 104 of FIGS. 2A and 2B, the spatial filter 218 is disposed behind the display 208. However, unlike the spatial filter 118 of the video user interface 104 of FIGS. 2A and 2B, in the video user interface 204 of FIG. 11, the spatial filter 218 is disposed between the lens 214 and the image sensor 216. The mobile electronic device further includes a processing resource 220. As indicated by the dashed lines in FIG. 11, the display 208, the image sensor 216 and the processing resource 220 are configured for communication. In all other respects, the video user interface 204 of FIG. 11 corresponds closely to the video user interface 104 of FIGS. 2A and 2B and the method of use of the video user interface 204 of FIG. 11 corresponds closely to the method of use of the video user interface 104 of FIGS. 2A and 2B described above.

Referring now to FIG. 12, there is shown a schematic cross-section of a second alternative video user interface generally designated 304 for use with a mobile electronic device for use in generating a depth image of a scene 330. The second alternative video user interface 304 of FIG. 12 has features which correspond to the features of the video user interface 104 of FIGS. 2A and 2B, with the features of the alternative video user interface 304 of FIG. 12 being identified with the same reference numerals as the corresponding features of the video user interface 104 of FIGS. 2A and 2B incremented by “200”. The video user interface 304 includes a transparent OLED display 308 which defines a front face 306 of the mobile electronic device. The video user interface 304 includes a camera 312 disposed behind the display 308, wherein the camera 312 includes a lens 314 and an image sensor 316. The video user interface 304 further includes a spatial filter 318 which defines a coded aperture. Like the spatial filter 118 of the video user interface 104 of FIGS. 2A and 2B, the spatial filter 318 is disposed behind the display 308. However, unlike the spatial filter 118 of the video user interface 104 of FIGS. 2A and 2B, in the video user interface 304 of FIG. 12, the spatial filter 318 is integrated with the lens 314, for example on a surface of the lens 314 or internally within the lens 314. The mobile electronic device further includes a processing resource 320. As indicated by the dashed lines in FIG. 12, the display 308, the image sensor 316 and the processing resource 320 are configured for communication. In all other respects, the video user interface 304 of FIG. 12 corresponds closely to the video user interface 104 of FIGS. 2A and 2B and the method of use of the video user interface 304 of FIG. 12 corresponds closely to the method of use of the video user interface 104 of FIGS. 2A and 2B described above.

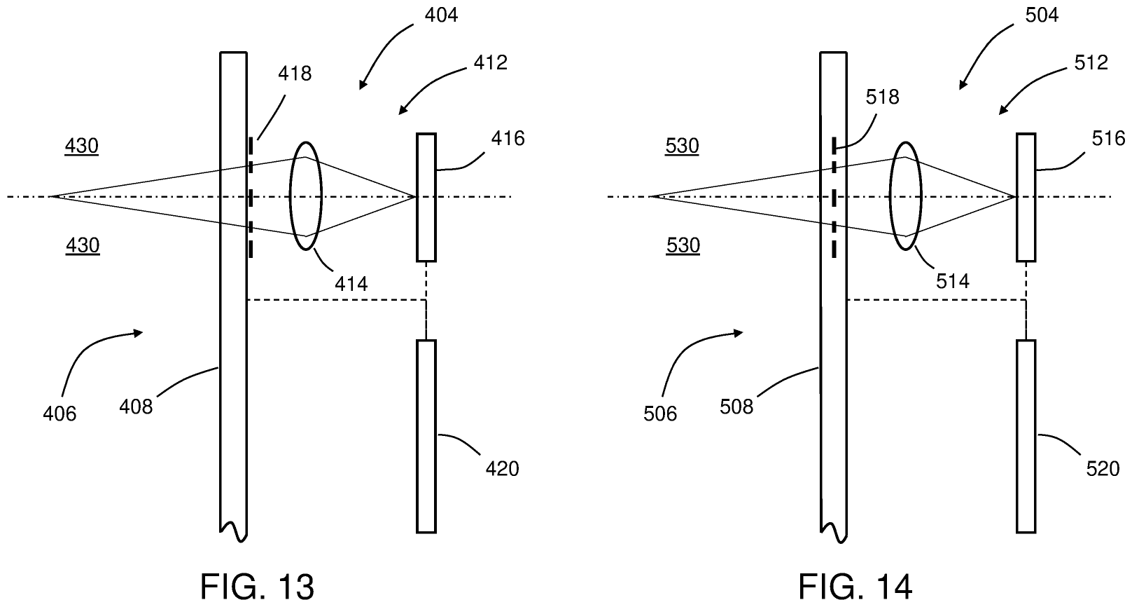

Referring now to FIG. 13, there is shown a schematic cross-section of a third alternative video user interface generally designated 404 for use with a mobile electronic device for use in generating a depth image of a scene 430. The third alternative video user interface 404 of FIG. 13 has features which correspond to the features of the video user interface 104 of FIGS. 2A and 2B, with the features of the alternative video user interface 404 of FIG. 13 being identified with the same reference numerals as the corresponding features of the video user interface 104 of FIGS. 2A and 2B incremented by “300”. The video user interface 404 includes a transparent OLED display 408 which defines a front face 406 of the mobile electronic device. The video user interface 404 includes a camera 412 disposed behind the display 408, wherein the camera 412 includes a lens 414 and an image sensor 416. The video user interface 404 further includes a spatial filter 418 which defines a coded aperture. Like the spatial filter 118 of the video user interface 104 of FIGS. 2A and 2B, the spatial filter 418 is disposed behind the display 408. However, unlike the spatial filter 118 of the video user interface 104 of FIGS. 2A and 2B, in the video user interface 404 of FIG. 13, the spatial filter 418 is disposed on a rear surface of the display 408. The mobile electronic device further includes a processing resource 420. As indicated by the dashed lines in FIG. 13, the display 408, the image sensor 416 and the processing resource 420 are configured for communication. In all other respects, the video user interface 404 of FIG. 13 corresponds closely to the video user interface 104 of FIGS. 2A and 2B and the method of use of the video user interface 404 of FIG. 13 corresponds closely to the method of use of the video user interface 104 of FIGS. 2A and 2B described above.

Referring now to FIG. 14, there is shown a schematic cross-section of a fourth alternative video user interface generally designated 504 for use with a mobile electronic device for use in generating a depth image of a scene 530. The fourth alternative video user interface 504 of FIG. 14 has features which correspond to the features of the video user interface 104 of FIGS. 2A and 2B, with the features of the alternative video user interface 504 of FIG. 14 being identified with the same reference numerals as the corresponding features of the video user interface 104 of FIGS. 2A and 2B incremented by “400”. The video user interface 504 includes a transparent OLED display 508 which defines a front face 506 of the mobile electronic device. The video user interface 504 includes a camera 512 disposed behind the display 508, wherein the camera 512 includes a lens 514 and an image sensor 516. The video user interface 504 further includes a spatial filter 518 which defines a coded aperture. Unlike the spatial filter 118 of the video user interface 104 of FIGS. 2A and 2B, the spatial filter 518 is defined by the display 508. Specifically, the display 508 may comprise one or more at least partially transparent areas and one or more at least partially opaque areas. The spatial filter 518 may be defined by the one or more at least partially transparent areas and the one or more at least partially opaque areas of the display. The plurality of spatial filter pixels may be defined by the one or more at least partially transparent areas and the one or more at least partially opaque areas of the display 518. The one or more at least partially transparent areas of the display 518 and/or the one or more at least partially opaque areas of the display 518 may be temporary or transitory. The display 518 may comprise a plurality of light emitting pixels. The light emitting pixels may define the spatial filter 518. The light emitting pixels may define the one or more at least partially transparent areas of the display 518 and/or the one or more at least partially opaque areas of the display 518. The display 518 may comprise one or more gaps between the light emitting pixels. The one or more gaps between the light emitting pixels may define the spatial filter 518. The light emitting pixels may define the one or more at least partially transparent areas of the display 518 and/or the one or more at least partially opaque areas of the display 518. The mobile electronic device further includes a processing resource 520. As indicated by the dashed lines in FIG. 14, the display 508, the image sensor 516 and the processing resource 520 are configured for communication. In all other respects, the video user interface 504 of FIG. 14 corresponds closely to the video user interface 104 of FIGS. 2A and 2B and the method of use of the video user interface 504 of FIG. 14 corresponds closely to the method of use of the video user interface 104 of FIGS. 2A and 2B described above.

One of ordinary skill in the art will understand that various modifications may be made to the video user interfaces and methods described above without departing from the scope of the present disclosure. For example, any of the image sensors 116, 216, 316, 416, 516 may be sensitive to visible light, for example any of the image sensors 116, 216, 316, 416, 516 may be a visible image sensor or an RGB image sensor. Any of the image sensors 116, 216, 316, 416, 516 may be sensitive to infra-red light such as near infra-red (NIR) light, for example any of the image sensors 116, 216, 316, 416, 516 may be an infra-red image sensor. The video user interface may comprise a plurality of image sensors. For example, the video user interface may comprise an infra-red image sensor defined by, or disposed behind, the display for use in generating a depth image of a scene disposed in front of the display as described above and a separate visible image sensor defined by, or disposed behind, the display for capturing conventional images of the scene disposed in front of the display. The video user interface may comprise a source, emitter or projector of infra-red light for illuminating the scene with infra-red light. The source, emitter or projector of infra-red light may be disposed behind the display. Use of a source, emitter or projector of infra-red light in combination with an infra-red image sensor for use in generating a depth image of a scene disposed in front of the display may provide improved depth information relating to the scene.

Any of the video user interfaces 104, 204, 304, 404, 504 described above may be used in an electronic device of any kind, for example a mobile and/or portable electronic device of any kind, including in a phone such as a mobile phone, a cell phone, or a smart phone, or in a tablet or a laptop.

Embodiments of the present disclosure can be employed in many different applications including in the recognition of one or more features in the scene. For example, any of the video user interfaces 104, 204, 304, 404, 504 may be suitable for use in the recognition of one or more features of a user, such as one or more features of a user, of the electronic device in the scene, for facial unlocking of the electronic device. Such a video user interface may allow emojis, or one or more other virtual elements, to be superimposed on top of an image of the scene captured by the image sensor through the coded aperture and the lens. Such a video user interface may allow the generation of an improved “selfie” image captured by the image sensor through the coded aperture and the lens. Such a video user interface may allow emojis, or one or more other virtual elements, to be superimposed on top of the “selfie” image captured by the image sensor through the coded aperture and the lens.

Although preferred embodiments of the disclosure have been described in terms as set forth above, it should be understood that these embodiments are illustrative only and that the claims are not limited to those embodiments. Those skilled in the art will understand that various modifications may be made to the described embodiments without departing from the scope of the appended claims. Each feature disclosed or illustrated in the present specification may be incorporated in any embodiment, either alone, or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of reference signs in the claims should not be construed as limiting the scope of the claims.

### LIST OF REFERENCE NUMERALS

2 mobile electronic device;
4 video user interface;
6 front face of mobile electronic device;
8 display;
9 notch;
10 notch cover;
12 camera;
14 lens;
16 image sensor;
20 processing resource;
30 scene;
102 mobile electronic device;
104 video user interface;
106 front face of mobile electronic device;
108 display;
112 camera;
114 lens;
116 image sensor;
118 spatial filter;
118a opaque spatial filter pixel;
118b transparent spatial filter pixel;
120 processing resource;
130 scene;
204 video user interface;
206 front face of mobile electronic device;
208 display;
212 camera;
214 lens;
216 image sensor;
218 spatial filter;
220 processing resource;
230 scene;
304 video user interface;
306 front face of mobile electronic device;
308 display;
312 camera;
314 lens;
316 image sensor;
318 spatial filter;
320 processing resource;
330 scene;
404 video user interface;
406 front face of mobile electronic device;
408 display;
412 camera;
414 lens;
416 image sensor;
418 spatial filter;
420 processing resource;
430 scene;
504 video user interface;
506 front face of mobile electronic device;
508 display;
512 camera;
514 lens;
516 image sensor;
518 spatial filter;
520 processing resource; and
530 scene.

1. A video user interface for an electronic device for use in determining depth information relating to a scene, the video user interface comprising:
a display;
a spatial filter defining a coded aperture, the spatial filter being disposed behind the display;
an image sensor; and
a lens,
wherein the image sensor and the lens are both disposed behind the display, and
wherein the spatial filter, the image sensor, and the lens are arranged to allow the image sensor to capture an image of a scene through the coded aperture and the lens, the scene being disposed in front of the display.

2. The video user interface as claimed in claim 1, wherein a least one of:
the spatial filter comprises a binary spatial filter;
the spatial filter comprises a plurality of spatial filter pixels, wherein the plurality of spatial filter pixels defines the coded aperture;
the spatial filter comprises a plurality of opaque spatial filter pixels;
the plurality of opaque spatial filter pixels define one or more gaps therebetween, wherein the one or more gaps define the coded aperture;
the spatial filter comprises a plurality of transparent spatial filter pixels, wherein the plurality of transparent spatial filter pixels define the coded aperture;
at least some of the opaque spatial filter pixels are interconnected or contiguous;
all of the opaque spatial filter pixels are interconnected or contiguous;
at least some of the opaque spatial filter pixels are non-contiguous;
at least some of the transparent spatial filter pixels are interconnected or contiguous;
at least some of the transparent spatial filter pixels are non-contiguous;
the spatial filter comprises a 2D array of spatial filter pixels, wherein the 2D array of spatial filter pixels defines the coded aperture;
the spatial filter comprises a uniform 2D array of spatial filter pixels, wherein the uniform 2D array of spatial filter pixels defines the coded aperture.

3. The video user interface as claimed in claim 1,
wherein the spatial filter comprises an n×n array of spatial filter pixels, wherein the spatial filter pixels define the coded aperture and wherein n is an integer, or wherein the spatial filter comprises an n×m array of spatial filter pixels, wherein the spatial filter pixels define the coded aperture and wherein n and m are integers.

4. The video user interface as claimed in claim 1, wherein at least one of:
the display is at least partially transparent;
an area of the display is at least partially transparent;
wherein the display comprises an LED display.

5. The video user interface as claimed in claim 1, wherein the display and the image sensor are synchronized so that the display emits light and the image sensor captures the image of the scene at different times.

6. The video user interface as claimed in claim 1, wherein:
the spatial filter is disposed between the display and the lens;
the spatial filter is disposed between the lens and the image sensor;
the spatial filter is integrated with the lens; or
the spatial filter is disposed on a rear surface of the display on an opposite side of the display to the scene.

7. The video user interface as claimed in claim 1,
wherein the display defines the spatial filter;
wherein the display comprises one or more at least partially transparent areas and one or more at least partially opaque areas;
wherein the spatial filter is defined by the one or more at least partially transparent areas and the one or more at least partially opaque areas; and
wherein the one or more at least partially transparent areas of the display and/or the one or more at least partially opaque areas of the display are temporary or transitory.

8. (canceled)

9. (canceled)

10. The video user interface as claimed in claim 7, wherein at least one of:
the display comprises a plurality of light emitting pixels;
the light emitting pixels define the spatial filter;
the light emitting pixels define the one or more at least partially transparent areas of the display and/or the one or more at least partially opaque areas of the display;
the display comprises one or more gaps between the light emitting pixels;
the one or more gaps between the light emitting pixels define the spatial filter;
the one or more gaps between the light emitting pixels define the one or more at least partially transparent areas of the display and/or the one or more at least partially opaque areas of the display; and/or
the one or more at least partially opaque areas of the display.

11. The video user interface as claimed in claim 1, wherein the image sensor comprises a visible image sensor sensitive to visible light, wherein the image sensor comprises an RGB image sensor or wherein the image sensor comprises an infra-red image sensor sensitive to infra-red light such as near infra-red (NIR) light.

12. (canceled)

13. (canceled)

14. The video user interface as claimed in claim 1, wherein a geometry of the coded aperture is selected so as to maximize a divergence parameter value, wherein the divergence parameter is defined so that the greater the divergence parameter value calculated for a given coded aperture geometry, the better the discrimination that is achieved between regions of different depths in the image of the scene captured by the image sensor when using the given coded aperture geometry.

15. The video user interface as claimed in claim 14, wherein calculating the divergence parameter value for each candidate coded aperture geometry comprises:
applying a plurality of different scale factor values to the geometry of the candidate coded aperture to obtain a plurality of scaled versions of the candidate coded aperture;
calculating a divergence parameter value for each different pair of scaled versions of the candidate coded aperture selected from the plurality of scaled versions of the candidate coded aperture; and
identifying the divergence parameter value for each candidate coded aperture geometry as the minimum divergence parameter value calculated for any different pair of scaled versions of the candidate coded aperture selected from the plurality of scaled versions of the candidate coded aperture.

16-17. (canceled)

18. The video user interface as claimed in claim 1, further comprising a processing resource configured to determine depth information relating to each of one or more regions of the scene based at least in part on the captured image and calibration data.

19. The video user interface as claimed in claim 18, wherein the calibration data comprises a plurality of calibration images of a plurality of calibration scenes and a corresponding plurality of measured depth values, wherein each calibration scene includes a point light source located at a different one of the measured depths and each calibration scene is captured by the image sensor through the coded aperture and the lens.

20. An electronic device comprising the video user interface as claimed in claim 1.

21. A method for use in determining depth information relating to a scene using a video user interface, wherein the video user interface comprises a display, a spatial filter defining a coded aperture, an image sensor and a lens, and the method comprises:
capturing an image of a scene through the coded aperture and the lens using the image sensor, the image sensor and the lens both being disposed behind the display, the scene being disposed in front of the display, and the spatial filter being disposed behind the display.

22. The method as claimed in claim 21, further comprising:
determining depth information relating to each of one or more regions of the scene based at least in part on the captured image and calibration data.

23. The method as claimed in claim 22, wherein the calibration data comprises a plurality of calibration images of a plurality of calibration scenes and a corresponding plurality of measured depth values, wherein each calibration scene includes a point light source located at a different one of the measured depths and each calibration scene is captured by the image sensor through the coded aperture and the lens.

24. The method as claimed in claim 22, further comprising generating an all-focus image of the scene and/or a re-focused image of the scene based on the determined depth information relating to each of one or more regions of the scene.

25. (canceled)

26. The method as claimed in claim 22, further comprising recognizing one or more features in the scene based on the determined depth information relating to each of the one or more regions of the scene.

27. The method as claimed in claim 26, further comprising unlocking the electronic device in response to recognizing one or more features in the scene.
